(19) United States
(12) Patent Application Publication
(10) Pub. No.: US 2026/0356992 A1
(43) Pub. Date: Nov. 12, 2026

(54) PROCESS FOR OBTAINING NATURAL RUBBER

(71) Applicant: Continental Reifen Deutschland GmbH, Hannover (DE)

(72) Inventors: Carla Recker, Hannover (DE); Katharina Herzog, Harsum (DE); Frank Behm, Sassen-Trantow (DE); Norbert Janczak, Guetzkow (DE); Carsten Venz, Neddemin (DE); Clemens Fichtner, Goettingen (DE)

(73) Assignee: Continental Reifen Deutschland GmbH, Hannover (DE)

(21) Appl. No.: 19/125,783

(22) PCT Filed: Oct. 16, 2023
(86) PCT No.: PCT/DE2023/200212

§ 371 Date: Apr. 30, 2025

(30) Foreign Application Priority Data
Nov. 2, 2022 (DE) 10 2022 211 567.8

(51) Int. Cl. C08C 4/00; B02C 17/18

(52) U.S. Cl. CPC C08C 4/00; B02C 17/18

(57) ABSTRACT

The invention relates to a process for obtaining natural rubber from plant material, the plant material being fed to a ball mill and discharged from a ball mill in a wet phase, the plant material being milled in a drum by means of milling media, wherein the natural rubber is extracted from the plant material by means of the ball mill in a continuous process.

### CROSS-REFERENCE TO RELATED APPLICATION

This application is a National Stage Application under 35 U.S.C. § 371 of International Patent Application No. PCT/DE2023/200212 filed on Feb. 10, 2023, and claims priority from German Patent Application No. 10 2022 211 567.8 filed on Nov. 2, 2022, the disclosures of which are herein incorporated by reference in their entireties.

### BRIEF SUMMARY

The invention relates to a process for obtaining natural rubber from plant material, the plant material being fed to a ball mill and discharged from a ball mill in a wet phase.

The invention further relates to a ball mill for obtaining natural rubber from plant material in a wet phase in continuous operation by means of a drum rotatable about a longitudinal axis by a motor.

Processes for obtaining natural rubber from plant material are known.

The disadvantage of such processes is that only a relatively small amount of natural rubber can be obtained per unit of time.

Against this background, it is an object of the invention to design a process and a ball mill such that relatively large amounts of natural rubber can be obtained efficiently, while ensuring that the natural rubber is of high quality.

This object is achieved by a process according to the features of claim 1 and by a ball mill according to the additional independent claim. The dependent claims relate to particularly advantageous developments of the invention.

The invention thus provides a process for obtaining natural rubber from plant material, the plant material being fed to a ball mill and discharged from a ball mill in a wet phase, the plant material being milled in a drum by means of milling media, wherein the natural rubber is extracted from the plant material by means of the ball mill in a continuous process.

The continuous extraction process achieves a higher plant material throughput than in the case of known batch systems of comparable size and of comparable costs as regards system procurement and system operation.

It is possible to assess the quality of the natural rubber that passes out of the drum during the process. This makes it possible to adjust the process parameters during the process on the basis of the process results. During the process, process parameters such as the speed of the drum or the volume flow rate of the plant material and of the wet phase can be adjusted. An increase in the quality of the natural rubber and an increase in the degree of utilization of the plant material is made possible.

A continuous process is in particular not a batch process. A continuous process is distinguished by the fact that the fill level in the drum is kept substantially constant throughout the extraction process, the feeding of material to be milled and the discharging of material that has been milled being part of a constant extraction process. Relatively small process-related fluctuations of the fill level or relatively small process-intended fluctuations of the fill level by up to 30% of the target volume of the plant material in the drum are consistent with a constant process.

In one advantageous embodiment, the plant material is fed to the drum by means of the inlet opening, preferably continuously, and discharged by means of an outlet opening, the inlet opening preferably having a smaller cross section than the outlet opening. An inlet opening for feeding of the plant material and an outlet opening for discharging of the plant material allow flow through the length of the drum in a simple form. A constant residence time and hence a constant degree of milling of the plant material is made possible as a result. A particularly constant residence time is achieved when the feeding is carried out constantly. The result is a high degree of utilization of the plant material together with a high quality of the natural rubber obtained.

The natural rubber extracted in the process floats in the form of flakes on the liquid phase. In the drum, there is ultimately a constant volume flow rate along the drum despite the rotation, with the flow velocity being the highest at the surface of the liquid phase. As a result, the natural rubber that has already been extracted is guided through the drum at a higher speed, is milled for a shorter time and is of a higher quality. It has been found to be advantageous when the inlet opening has a smaller cross section than the outlet opening, since this ensures that the plant material passes out of the outlet opening, even in the case of a horizontal drum.

According to a further preferred embodiment, the plant material is conveyed via a conical region of the drum toward the outlet opening, the conical region having preferably an angle of 10° to 170°, more preferably of 20° to 150° and more preferably of 30° to 120°. The conveying of the plant material via a conical region toward the outlet opening reduces the accumulation of plant material residues in the region before the outlet opening that have an adverse effect on the natural rubber quality. An angle of 10° to 170°, particularly an angle of 20° to 150° and more particularly an angle of 30° to 120° have been found to be particularly advantageous.

In one advantageous embodiment, the drum is made to continuously rotate and preferably the plant material is continuously fed to the drum and/or discharged from the drum. Continuous rotation is rotation with as few interruptions as possible and with preferably a constant target speed. Relatively short interruptions which do not have any relevant influence on the process are nevertheless possible, for example in order to collect samples from the drum or to change the direction of rotation of the drum. Continuous rotation maximizes the proportion of time in which the process is in progress and thus the plant material throughput. Furthermore, continuous rotation makes it possible for the natural rubber to have as consistent a quality as possible. Continuous feeding and/or discharging of plant material to and/or from the drum produces a constant volume flow rate of the plant material through the drum and thereby makes it possible for the natural rubber to have as constant a quality as possible.

According to a further advantageous embodiment, a partial amount, preferably between 0.05% and 30%, more preferably between 0.25% and 20% and more preferably between 0.5% and 10%, of the plant material present in the drum is removed from or fed to the drum as a surge. Any plant material residues adhering to the drum surface, in particular in the region of the exit opening, can be detached or be brought into suspension and washed away.

In one advantageous embodiment, the plant material is milled by means of a nonmetallic surface of the drum and/or a nonmetallic surface of the milling media of the ball mill. Since metallic surfaces coming into contact with the plant material during milling reduce the quality of the natural rubber, an improvement in natural rubber quality is made possible by nonmetallic surfaces of the drum and the milling media.

In one advantageous embodiment, the nonmetallic surfaces of the drum and/or the nonmetallic surfaces of the milling media are free of iron and preferably free of heavy metals and/or transition metals. Heavy metals and transition metals, in particular iron, for example in the form of salts, that can lead to a reduction in natural rubber quality may be present in nonmetallic surfaces. As a result, the aging resistance of the natural rubber can be improved in particular.

In one advantageous embodiment, the drum is cylindrical over the majority of its length, the longitudinal axis of the drum being horizontal or inclined toward the outlet opening, preferably between 0° and 20°, more preferably between 0° and 15°, more preferably between 0° and 12° and more preferably between 0° and 10°. A horizontal orientation of the longitudinal axis of the drum makes it possible for the entry opening and the exit opening to be arranged horizontally to one another at the ends of the drum, the entry opening and the exit opening being concentric in relation to the longitudinal axis. A particularly high degree of filling of the drum is made possible. Inclination of the drum toward the exit opening allows a higher flow velocity of the plant material in the longitudinal direction of the drum, thus making it possible to reduce the residence time of the plant material in the drum and to increase the volume flow rate through the drum.

In one advantageous embodiment, the plant material is milled by means of a ceramic, preferably an alumina ceramic, vitreous, mineral and/or polymeric surface of the drum and/or a ceramic, preferably an alumina ceramic, vitreous, mineral and/or polymeric surface of the milling media. Ceramic, preferably alumina ceramic, vitreous, mineral and/or polymeric surfaces have been found to be particularly suitable as surfaces for drums and for milling media, since they are resistant to the milling process and do not have an adverse influence on the quality of the natural rubber. It has been found to be particularly advantageous to choose the same surface for the drum and for the milling media, since this produces particularly resistant surfaces with respect to the milling process.

In one advantageous embodiment, the ball mill is a drum mill or a tube mill. The use of drum mills and tube mills in processes for obtaining natural rubber has been found to lead to a particularly good result, both with respect to natural rubber quality and with respect to the degree of utilization of the plant material and to plant material throughput.

In one advantageous embodiment, the plant material is cleaned and/or precomminuted before milling in the ball mill, the precomminuted plant material having preferably an extent of 0.5 mm to 16 mm and more preferably an extent of 1 mm to 8 mm. Cleaning of the plant material before milling of the plant material reduces the accumulation of residues in the drum. Furthermore, the quality of the natural rubber is increased, since adverse influences on the natural rubber due to soiling are avoided. Precomminution has been found to lead to a better natural rubber quality. A possible reason for this is the greater homogeneity of the initial size of the plant material at the start of milling. Precomminution homogenizes the inhomogeneous initial plant material with respect to the dimensions thereof. As a result, the milling process acts more uniformly on the individual constituents of the plant material.

In one advantageous embodiment, the plant material originates from the plant genus dandelion (Taraxacum), preferably the Russian dandelion (Taraxacum kok-saghyz) or offspring (hybrids) thereof. The plant material essentially comprises the roots and the hypocotyl. Dandelion (Taraxacum), in particular Russian dandelion (Taraxacum kok-saghyz) or offspring (hybrids) thereof, has been found to have a particularly high content of natural rubber and also to have the property of releasing natural rubber particularly efficiently in the process according to the invention.

In principle, the process according to the invention can be applied to all plant species suitable for obtaining natural rubber. Besides Hevea brasiliensis, examples of such plants include members of the Asteraceae, such as Taraxacum sp. or Scorzonera sp., in particular Taraxacum kok-saghyz, Taraxacum krim-saghyz, Taraxacum bicorne, Taraxacum brevicorniculatum, or Scorzonera tau-saghyz, Scorzonera Uzbekistanica, Scorzonera teke-saghyz, Scorzonera hispanica, Scorzonera tausaghyz, or guayule (Parthenium argentatum), or other species such as Apocynum venetum, Asclepias incarnata, Asclepias cornuti, Asclepias sub-lata, Asclepias syrica, Cacalia atriplicifolia, Campanula america, Chicorium intybus, Chondrilla ambigua, Chondrilla pauciflora, Crysothamnus nauseousus, Cryptostegia grandiflora, Euphorbia lathyris, Lactuca serriola, Lactuca sativa, Parthenium incanum, Pycnanthemum incanum, Solidago altissima, Solidago graminifolia, Solidago leavenworthii, Solidago rigida, Sonchus arvensis, Sonchus oleraceous, Teucreum canadense, or Silphium sp., or mixtures of these plants and also naturally occurring or cultivated hybrids of the aforementioned species.

In one advantageous embodiment, the wet phase comprises plant material and water and preferably consists of the plant material and water. Adding water to the plant material in order to produce the wet phase has been found to be advantageous, since natural rubber floats on aqueous solutions and can therefore be separated from the wet phase effectively. Furthermore, water has been found to be particularly suitable because many plant constituents dissolve in the aqueous solution. Preferably, the wet phase consists of plant material and water, so that separation of water from other liquids can be dispensed with and a process operable in a cost-effective and environmentally friendly manner is made possible. Evaporated constituents from the wet phase can harmlessly enter the environment.

In one advantageous embodiment, a partial amount of the plant material discharged from the drum by means of the outlet opening is fed to the drum by means of the inlet opening. A short milling time for dissolved natural rubber is beneficial for its quality. However, a short residence time of the plant material reduces the proportion of natural rubber extracted from the plant material. This embodiment makes it possible to achieve a high degree of utilization of the plant material together with a high quality of the natural rubber. A particularly short residence time of the plant material in the drum is chosen, and the extracted natural rubber is separated from the remaining plant material after leaving the drum. The extracted natural rubber experiences a short milling time. At least a portion of the remainder of the plant material is refed to the inlet opening, and it is preferably stored temporarily in a material buffer. In this connection, the remainder of the plant material can undergo separation, such that especially plant material having a high content of natural rubber is refed to the inlet opening. The degree of utilization of the plant material is increased.

The invention provides a ball mill comprising milling media for obtaining natural rubber from plant material in a wet phase in continuous operation by means of a drum rotatable about a longitudinal axis by a motor, an inlet opening being arranged on one end face of the drum and an outlet opening being arranged on another end face of the drum.

The ball mill achieves a higher plant material throughput than in the case of known batch systems of comparable size and of comparable costs as regards system procurement and system operation.

The ball mill together with the novel continuous process makes it possible to assess the quality of the natural rubber that passes out of the drum during the process. This makes it possible to adjust the process parameters during the operation of the ball mill on the basis of the process results. During the operation of the ball mill, process parameters such as the speed of the drum or the volume flow rate of the plant material and of the wet phase can be adjusted. An increase in the quality of the natural rubber and an increase in the degree of utilization of the plant material is made possible.

In one advantageous embodiment of the ball mill, the inlet opening has a smaller cross section than the outlet opening. This ensures that the plant material passes out of the outlet opening, even in the case of a horizontal drum.

In another advantageous embodiment of the ball mill, the drum has an extension element to extend the residence time of the plant material in the ball mill. Owing to the extension element, which is mountable between an entry element and an exit element, the drum is extendable, thus making it possible to increase the residence time of the plant material in the drum while keeping other process parameters constant. Alternatively, it is also possible to perform a higher plant material throughput while residence time remains unchanged.

In another advantageous embodiment of the ball mill, the nonmetallic surfaces are free of iron and preferably free of heavy metals and/or transition metals, the nonmetallic surfaces preferably consisting of a ceramic, preferably an alumina ceramic or for example porcelain, vitreous, mineral and/or polymeric material. Such surfaces have been demonstrated to be resistant to the milling process and have not shown any adverse influence on the quality of the natural rubber.

In another advantageous embodiment of the ball mill, the outlet opening is closable, preferably by means of a flap or a valve. This makes it possible to discharge the plant material as a surge in a simple manner.

The invention provides for a use of a ball mill according to the invention, the ball mill comprising milling media for milling plant material to obtain natural rubber from plant material, the ball mill being used in a continuous process.

The invention provides a computer program product for carrying out a process according to the invention for obtaining natural rubber from plant material, comprising commands which, on execution of the program by at least a processor unit, cause said processor unit to execute the process according to the invention.

### BRIEF DESCRIPTION OF THE SEVERAL VIEWS OF THE DRAWINGS

The invention permits numerous embodiments. To further illustrate its basic principle, one of these embodiments is illustrated in the drawings and will be described in the following text. In the drawing:

FIG. 1 shows a representation of the process for obtaining rubber, with upstream and downstream process steps;

FIG. 2 shows a cross section of a ball mill;

FIG. 3 shows a longitudinal section of a ball mill.

### DETAILED DESCRIPTION

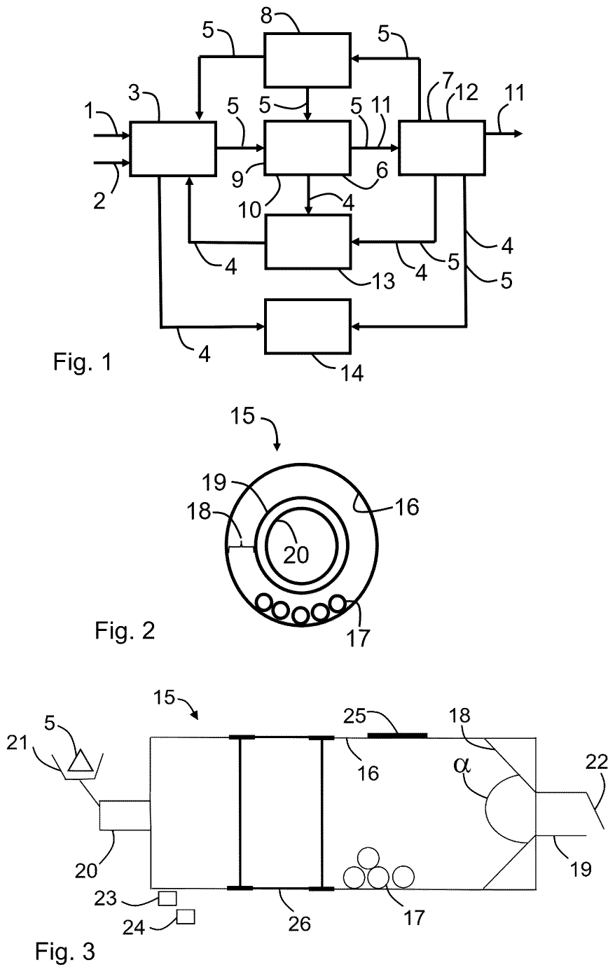

FIG. 1 shows a representation of the process for obtaining rubber from dandelion, with upstream and downstream process steps. In a first process step, fresh roots 1 from dandelion and fresh water 2 are fed to a preconditioning device 3. In the preconditioning device 3, the fresh roots 1 are cleaned by the fresh water 2 and preconditioned by way of further process steps. Furthermore, the preconditioning device 3 may be fed process water 4 that has been treated and root material 5 that has already passed through an extraction step 6 once followed by separation in a separation step 7 and temporary storage in a material buffer 8.

After the preconditioning, the root material 5 is fed to an extraction unit 9. In the extraction unit 9, which is in the form of a ball mill 10, the root material 5 is further comminuted. The root constituents are parted from one another, with natural rubber 11 in particular being parted from the remaining root material 5. To this end, the ball mill 10 is fed fresh water 2 or process water 4. Following extraction step 6, the root material 5 and the natural rubber 11 are conveyed to a separation unit 12. The separation unit 12 separates the natural rubber 11 from the remainder of the root material 5. A portion of the remainder of the root material 5 is fed with the process water 4 to a water treatment 13 and separated thereby into process water 4 and residues. The process water 4 can then be fed to the preconditioning device 3. The water treatment 13 can be fed process water 4 from the extraction unit 9.

A second portion of the remainder of the root material 5 or the entire material and the process water 4 can be fed from the separation unit 12 to a disposal unit 14. The disposal unit 14 is additionally fed process water 4 from the preconditioning device 3.

A third portion of the remainder of the root material 5 or the entire material from the separation unit 12 can be fed to the material buffer 8 and can, from there, be conveyed further into the preconditioning device 3 or into the extraction unit 9.

FIG. 2 shows a cross section of a drum 15 of the ball mill 10. The drum 15 has an inner surface 16 that comes into contact with milling media 17 and mills the root material 5. The surface 16 and the milling media 17 consist of an alumina ceramic. On the exit side, the drum 15 has a conical region 18 leading from the cylindrical region to an outlet opening 19, the outlet opening 19 having a larger diameter than the inlet opening 20.

FIG. 3 shows a longitudinal section of the drum 15 having, as shown on the left, an inlet opening 20 which is supplied with root material 5 by means of a filler neck 21. The root material 5 is conveyed into the drum 15 via a screw conveyor. The drum 15 has an inner surface 16 which is cylindrical over the majority of the length of the drum 15. The cylindrical region is followed by a conical region 18 of the surface 16 that connects the cylindrical region to the outlet opening 19. Provided at the outlet opening 19 is a flap 22 by means of which the outlet opening 19 can be closed. Release of a surge of the root material 5 and the natural rubber 11 is made possible by setting the fill level in the drum 15 such that the root material 5 and the natural rubber 11 are against the flap 22 and it is opened. Present in the drum 15 are milling media 17 for milling the root material 5. The drum 15 is driven by a motor 23. The motor 23 and the other actuators such as pumps are controlled by a processor unit 24. A maintenance hole 25 makes it possible to carry out maintenance work inside the drum 15 in a simple manner. The drum 15 has an extension element 26 which can be arranged in a central region of the drum 15 between the inlet opening 20 and the outlet opening 19. The drum 15 can be used in different lengths, thereby making it possible to vary the residence time of the root material 5 in the drum 15.

### LIST OF REFERENCE SIGNS

1 Fresh roots
2 Fresh water
3 Preconditioning device
4 Process water
5 Root material
6 Extraction step
7 Separation step
8 Material buffer
9 Extraction unit
10 Ball mill
11 Natural rubber
12 Separation unit
13 Water treatment
14 Disposal unit
15 Drum
16 Surface
17 Milling media
18 Conical region
19 Outlet opening
20 Inlet opening
21 Filler neck
22 Flap
23 Motor
24 Processor unit
25 Maintenance hole
26 Extension element

1. A process for obtaining natural rubber from plant material,
the plant material being fed to a ball mill and discharged from a ball mill in a wet phase,
the plant material being milled in a drum by means of milling media, wherein
the natural rubber is extracted from the plant material by means of the ball mill in a continuous process.

2. The method as claimed in claim 1,
wherein
the plant material is fed to the drum by means of the inlet opening, preferably continuously, and discharged by means of an outlet opening,
the inlet opening preferably having a smaller cross section than the outlet opening.

3. The method as claimed in claim 1, wherein
the plant material is conveyed via a conical region of the drum toward the outlet opening, the conical region having preferably an angle of 10° to 170°, more preferably of 20° to 150° and more preferably of 30° to 120°.

4. The method as claimed in claim 1, wherein
the drum is made to continuously rotate and preferably the plant material is continuously fed to the drum and/or discharged from the drum.

5. The method of claim 1, wherein
wherein
a partial amount, preferably between 0.05% and 30%, more preferably between 0.25% and 20% and more preferably between 0.5% and 10%, of the plant material present in the drum is removed from or fed to the drum as a surge.

6. The method of claim 1, wherein
the plant material is milled by means of a nonmetallic surface of the drum and/or a nonmetallic surface of the milling media of the ball mill.

7. The method of claim 1, wherein
the nonmetallic surfaces of the drum and/or the nonmetallic surfaces of the milling media are free of iron and preferably free of heavy metals and/or transition metals.

8. The method of claim 1, wherein
the drum is cylindrical over the majority of its length,
the longitudinal axis of the drum being horizontal or inclined toward the outlet opening, preferably between 0° and 20°, more preferably between 0° and 15°, more preferably between 0° and 12° and more preferably between 0° and 10°.

9. The method of claim 1, wherein
the plant material is milled by means of a ceramic, preferably an alumina ceramic, vitreous, mineral and/or polymeric surface of the drum and/or a ceramic, preferably an alumina ceramic, vitreous, mineral and/or polymeric surface of the milling media.

10. The method of claim 1, wherein
the ball mill is a drum mill or a tube mill.

11. The method of claim 1, wherein
the plant material is cleaned and/or precomminuted before milling in the ball mill, the precomminuted plant material having preferably an extent of 0.5 mm to 16 mm and more preferably an extent of 1 mm to 8 mm.

12. The method of claim 1, wherein
the plant material originates from the plant genus dandelion, preferably the Russian dandelion or offspring thereof, and essentially comprises the roots and the hypocotyl.

13. A ball mill comprising milling media for obtaining natural rubber from plant material in a wet phase in continuous operation by means of a drum rotatable about a longitudinal axis by a motor,
an inlet opening being arranged on one end face of the drum and an outlet opening being arranged on another end face of the drum.

14. The ball mill of claim 13, wherein
the inlet opening has a smaller cross section than the outlet opening.

15. The ball mill of claim 13, wherein
the drum has an extension element to extend the residence time of the plant material in the ball mill.

16. A method of obtaining rubber from dandelion, the method comprising:
cleaning fresh roots by a preconditioning device to obtain root material;
extracting natural rubber from the root material using a drum of a ball mill, wherein the extracting natural rubber comprises:
feeding the root material into a drum with an inlet opening;
arranging an extension element to have a selected length to provide a residence time within the drum;
driving the drum by a motor controlled by a processor unit;
milling the root material with milling media in a cylindrical region of the drum that has an inner surface that comes into contact with milling media comprised of alumina ceramic;
setting a fill level of the drum to have the natural rubber against a flap at an outlet opening;
opening the flap to exit the natural rubber from the cylindrical region by way of a conical region to the outlet opening.

17. The method of claim 16, further comprising performing maintenance work inside the drum by a maintenance hole.

18. The method of claim 16, wherein the milling media is alumina ceramic.

19. A drum for extracting natural rubber from dandelions, the drum comprising:
a cylindrical region having milling media;
an inlet opening having an inlet diameter, the inlet for receiving dandelions as root material;
a screw conveyor to convey the root material into the cylindrical region;
an outlet opening having a flap and an opening diameter larger than the inlet diameter, the outlet opening configured to exit natural rubber;
an extension element arranged between the inlet opening and the outlet opening, the extension element arranged to one of a plurality of lengths based on a residence time of the root material;
a motor to drive the drum and mill the root material with the milling media; and
a processor unit to control the motor and one or more pumps and actuators.

20. The drum of claim 19, further comprising a conical region that connects the cylindrical region to the outlet opening.
